(19) United States
(12) Patent Application Publication
(10) Pub. No.: US 2015/0174598 A1
(43) Pub. Date: Jun. 25, 2015

(54) SPRAY GUN FOR USE WITH A PRESSURE WASHER

(71) Applicant: Techtronic Outdoor Products Technology Limited, Hamilton (BM)

(72) Inventor: Sven Eschrich, Berglen (DE)

(73) Assignee: Techtronic Outdoor Products Technology Limited, Hamilton (BM)

(21) Appl. No.: 14/135,805

(22) Filed: Dec. 20, 2013

(51) Int. Cl. B05B 9/01; B05B 12/00

(52) U.S. Cl. CPC B05B 9/01; B05B 12/002

(57) ABSTRACT

A spray gun for use with a pressure washer including a body with a nozzle and a handle. A trigger is coupled to the body and pivotable relative to the handle. A conduit extends through the nozzle and defines a fluid outlet. A valve housing defines a fluid inlet and includes a first chamber, a second chamber, and a valve seat including an aperture. A piston includes a valve member moveably disposed within the first chamber and a linkage extending between the trigger and the valve member. A biasing mechanism is positioned within the chamber and biases the valve member such that at least a portion of the valve member is retained within the aperture. Actuation of the trigger displaces the valve member and the linkage against the bias of the biasing mechanism to selectively allow fluid to flow from the inlet to the outlet through the aperture.

### BACKGROUND OF THE INVENTION

The present invention relates to spray gun for a pressure washer.

Spray guns often include unloader valves, which typically provide an ON/OFF configuration for providing or preventing pressurized fluid flow therethrough. When the gun trigger is pulled by the user, fluid is released from the gun at a pressure defined by the selected nozzle. When the trigger is released, no fluid is released from the gun. Therefore, the pressure of the fluid released from the spray gun is either at a maximum or no pressure.

### SUMMARY OF THE INVENTION

In one aspect, the invention provides a spray gun for use with a pressure washer. The spray gun includes a body with a nozzle and a handle. A trigger is coupled to the body and pivotable relative to the handle. A conduit extends through the nozzle and defines a fluid outlet. A valve housing is coupled to the conduit and defines a fluid inlet. The valve housing includes a first chamber spaced apart from a second chamber and a valve seat including an aperture separating the two chambers. A piston includes a valve member and a linkage. The valve member is moveably disposed within the first chamber and the linkage extends between the trigger and the valve member. A biasing mechanism is positioned within the first chamber. The trigger is pivotable between a first position, in which the biasing mechanism biases the valve member such that at least a portion of the valve member is retained within the aperture in the valve seat, and a second position, in which the valve member is spaced apart from the valve seat against the bias of the biasing mechanism. The pivotal movement of the trigger between the first position and the second position selectively determines an amount of fluid that passes from the fluid inlet to the fluid outlet.

In another aspect, the invention provides a spray gun for use with a pressure washer including a body with a nozzle and a handle. A trigger is coupled to the body and pivotable relative to the handle. A conduit extends through the nozzle and defines a fluid outlet. A valve housing is coupled to the conduit and defines a fluid inlet. The valve housing includes a first chamber spaced apart from a second chamber and separated by a valve seat including an aperture. A piston includes a valve member and a linkage. The valve member is moveably disposed within the first chamber and the linkage extends between the trigger and the valve member. A biasing mechanism is positioned within the chamber and configured to bias the valve member such that at least a portion of the valve member is retained within the aperture in the valve seat. Actuation of the trigger displaces the valve member and the linkage against the bias of the biasing mechanism to selectively allow fluid to flow from the inlet to the outlet through the aperture.

In another aspect, the invention provides a pressure washer for pressurizing and spraying fluid from a source of fluid. The pressure washer includes a base including at least a base fluid inlet configured to connect to the source of fluid and a pump including a base fluid outlet. The pressure washer also includes a spray gun having a body including a nozzle and a handle. The spray gun includes a trigger coupled to the body and pivotable relative to the handle. A conduit extends through the nozzle and defines a spray gun fluid outlet. A valve housing is coupled to the conduit and defines a spray gun fluid inlet. The valve housing includes a first chamber spaced apart from a second chamber and is separated by a valve seat including an aperture. A piston includes a valve member and a linkage. The valve member is moveably disposed within the chamber and the linkage extends between the trigger and the valve member. A biasing mechanism is positioned within the chamber and is configured to bias the valve member such that at least a portion of the valve member is retained within the aperture in the valve seat. The pressure washer includes a hose, which provides fluid communication from the base fluid outlet to the spray gun fluid inlet. Actuation of the trigger displaces the valve member and the linkage against the bias of the biasing mechanism to selectively allow fluid to flow from the source to the spray gun fluid inlet through the aperture.

Other aspects of the invention will become apparent by consideration of the detailed description and accompanying drawings.

### BRIEF DESCRIPTION OF THE DRAWINGS

FIG. 1 is perspective view of a pressure washer coupled to a spray gun by a hose.

FIG. 2 is a perspective view of the spray gun of FIG. 1 including a trigger.

FIG. 3 is a side view of the spray gun of FIG. 2 with a portion removed to illustrate a valve housing.

FIG. 4 is an enlarged-cross sectional view of the valve housing of FIG. 3 along the line 4-4 of FIG. 2.

FIG. 5 is a cross-sectional view of the spray gun of FIG. 2 along the line 5-5 illustrating the trigger in a first position.

FIG. 6 is a cross-sectional view of the spray gun of FIG. 2 along the line 5-5 illustrating the trigger in an intermediate position.

FIG. 7 is a cross-sectional view of the spray gun of FIG. 2 along the line 5-5 illustrating the trigger in a second position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION OF THE DRAWINGS

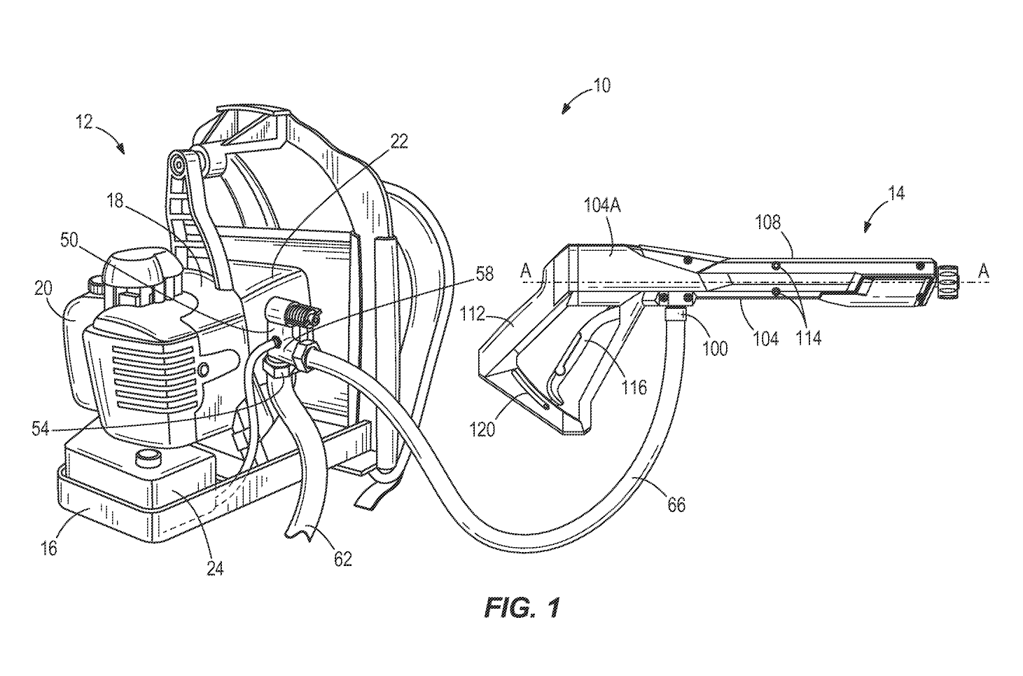

FIG. 1 illustrates a pressure washer system 10 including a pressure washer 12 and a single-flow spray gun 14 configured to deliver a high pressure fluid from the pressure washer 12. The illustrated pressure washer 12 is merely exemplary and pressure washers having other configurations and features are contemplated.

Further with respect to FIG. 1, the illustrated pressure washer 12 has a base or frame 16 that supports components of the pressure washer 12 and is configured to be portably carried upon a back of a user. Components of the pressure washer 12 include an engine 18, a fuel tank 20, a high pressure pump system 22 and a cleaning solution tank 24. The engine 18 drives the pump system 22 for increasing the pressure of fluid from a fluid source, such as water from an outdoor residential faucet. The pump 22 may be one of many different types of positive displacement pumps or centrifugal pumps suitable for providing relatively high pressure flows at relatively constant flow rates. An outdoor residential faucet typically provides water between approximately 40-80 psi, which is further pressurized by the high pressure pump system 18. The pressurized fluid can be used for cleaning or other purposes.

The pump 22 is coupled to a pump manifold 50 having an inlet connector 54 and an outlet connector 58. The inlet connector 54 is configured to receive a fluid supply line 62, such as a garden hose or a similar liquid flow apparatus delivering fluid from a remote fluid source, such as a municipal or local water source. In other constructions, the inlet connector 54 could receive a fluid supply line from a liquid storage tank. The outlet connector 58 is configured to be coupled to the spray gun 14, or other fluid delivery device in other constructions, to communicate the high pressure fluid from the pressure washer 12 to the spray gun 14.

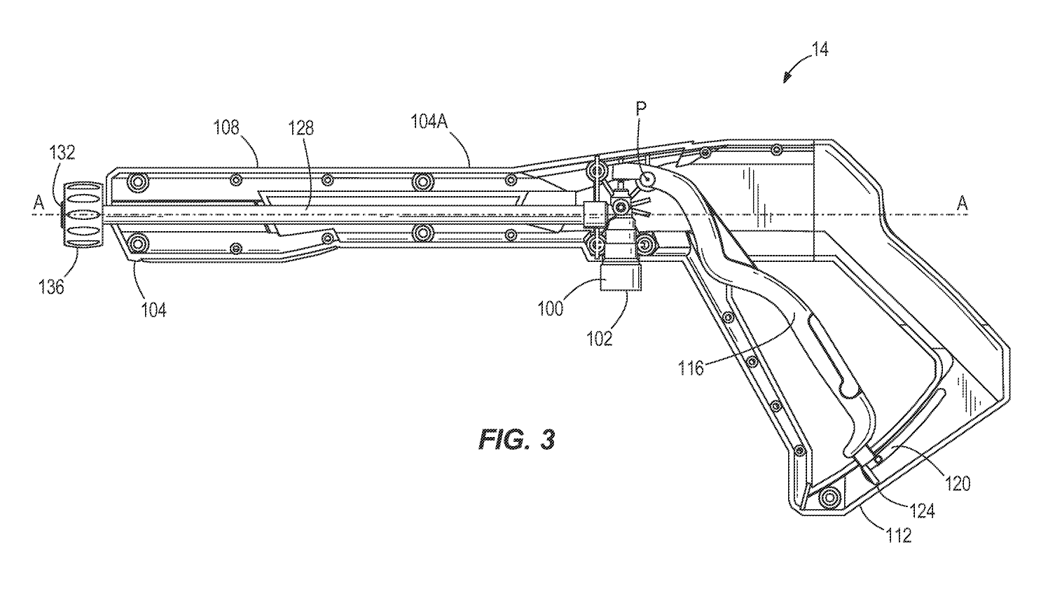

A hose 66 is removably coupled to the outlet connector 58 of the pump 22 and to a valve housing 100 (FIG. 3) of the spray gun 14 to receive the high pressure fluid from the pump 22 and communicate the high pressure fluid to the spray gun 14. The valve housing 100 defines a spray gun fluid inlet 102, and will be described in greater detail below. The hose 66 is removably coupled thereto with connectors that are configured to allow for relatively high pressure flow provided from the pump 22, such as compression fittings or other structures that require external tools for connection and removal. The connectors are disposed upon the mounting portions of the hose 66, and may be quick-connect couplers, threaded connectors, or the like. In a further construction, the hose 66 is permanently coupled to one or both of the outlet connector 58 and the spray gun 14.

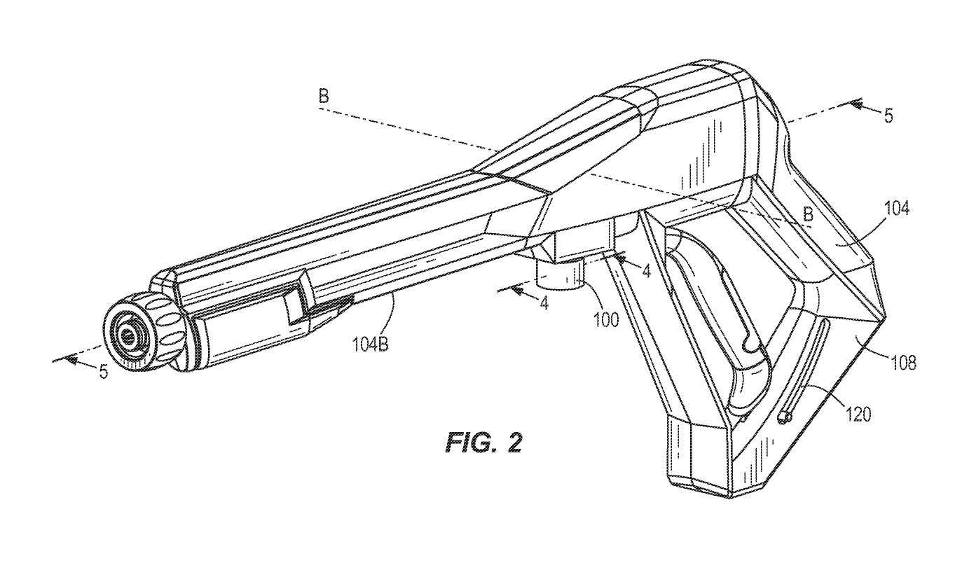

With respect to FIGS. 1 and 2, in particular, the spray gun 14 includes body 104 having a nozzle 108 and a handle 112. In the illustrated embodiment, the body 104 includes a first clamshell housing 104A and a second clamshell housing 104B. The clamshell housings 104A, 104B are secured to one another by fasteners 114 (i.e., screws and the like). The spray gun 14 further includes an actuator or trigger 116 that is coupled to the body 104 and pivotable relative to the handle 112. The trigger 116 allows a user to hold the spray gun 14 with a single hand and to operate the spray gun 14 with their fingers. In the illustrated embodiment, a first end of the trigger 116 is pivotally coupled to the body 104 and a second end of the trigger 116 is slideable within a channel 120 in the handle 112. In particular, an extension member 124 of the trigger 116 is received within the channel 120 to guide the trigger 116 along an arcuate path as the first end of the trigger pivots about the pivot P. As illustrated, the trigger 116 pivots about an axis B (FIG. 2) that is perpendicular to a longitudinal axis A (FIGS. 1 and 3) of the spray gun 14. In alternative or additional embodiments, the trigger 116 may have other configurations.

An internal conduit 128 extends through the nozzle 108 and defines a spray gun fluid outlet 132, which is located at an extended end of a wand or lance 136 of the spray gun 14. The internal conduit 128 provides fluid communication between the spray gun fluid inlet 102 and the spray gun fluid outlet 132. The spray gun fluid outlet 132 may be configured to receive an attachment (not shown) thereon to cause the fluid emitted therefrom to flow in a predetermined pattern. The attachment may be configured to emit a relatively high pressure spray flow and is preferably selected to provide the relatively high pressure flow upon a concentrated area for best cleaning.

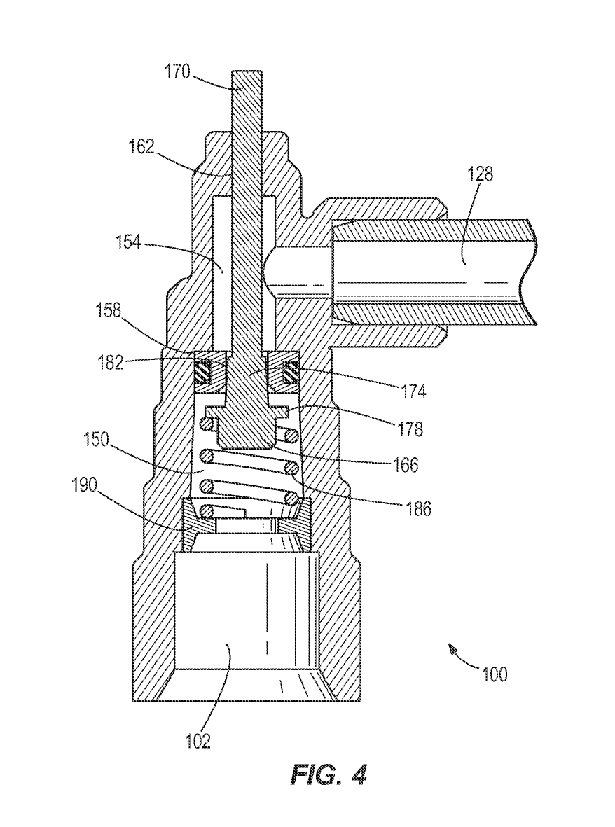

As illustrated in FIGS. 3 and 4, the valve housing 100 includes a first chamber 150 that is spaced apart from a second chamber 154 by a first valve seat 158. The valve housing 100 is coupled to the internal conduit 128 such that fluid is guided from the spray gun fluid inlet 102 to the internal conduit 128. In particular, the conduit 128 is in fluid communication with the second chamber 154 of the valve housing 100. A piston 162 is seated in the valve housing 100, and includes a valve member 166 and an elongate member or linkage 170. The linkage 170 is coupled to the trigger 116 and extends between the valve member 166 and the trigger 116 at least partially within the second chamber 154. The valve member 166 is moveably disposed within the first chamber 150. The valve member 166 includes a body 104 having a substantially conical portion 174 defining a substantially tapered outer diameter. The valve member 166 also includes a circumferential flange 178. The valve member 166 is configured such that the conical portion 174 is at least partially received by an aperture 182 extending through the first valve seat 158 to prevent fluid flow between the first chamber 150 and the second chamber 154. A biasing mechanism or spring 186 is positioned within the first chamber 150 between the first valve seat 158 and a second valve seat 190 adjacent to the spray gun fluid inlet 102. The biasing mechanism 186 acts on the flange 178 to bias the valve member 166 towards the first valve seat 158.

The spray gun 14 defines a fluid flow path therethrough. In particular, fluid enters the spray gun 14 through the spray gun fluid inlet 102. Fluid moves from the inlet 102 through the first chamber 150 and aperture 182 in the first valve seat 158 to the second chamber 154. The fluid moves from the second chamber 154 through the conduit 128 to the spray fun fluid outlet 132.

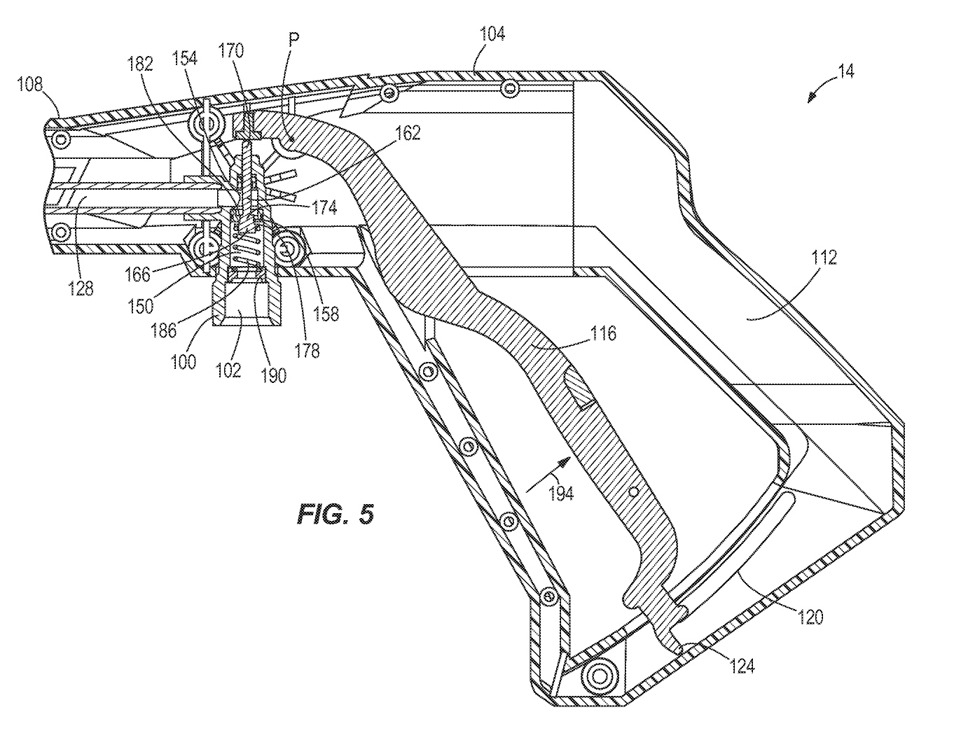

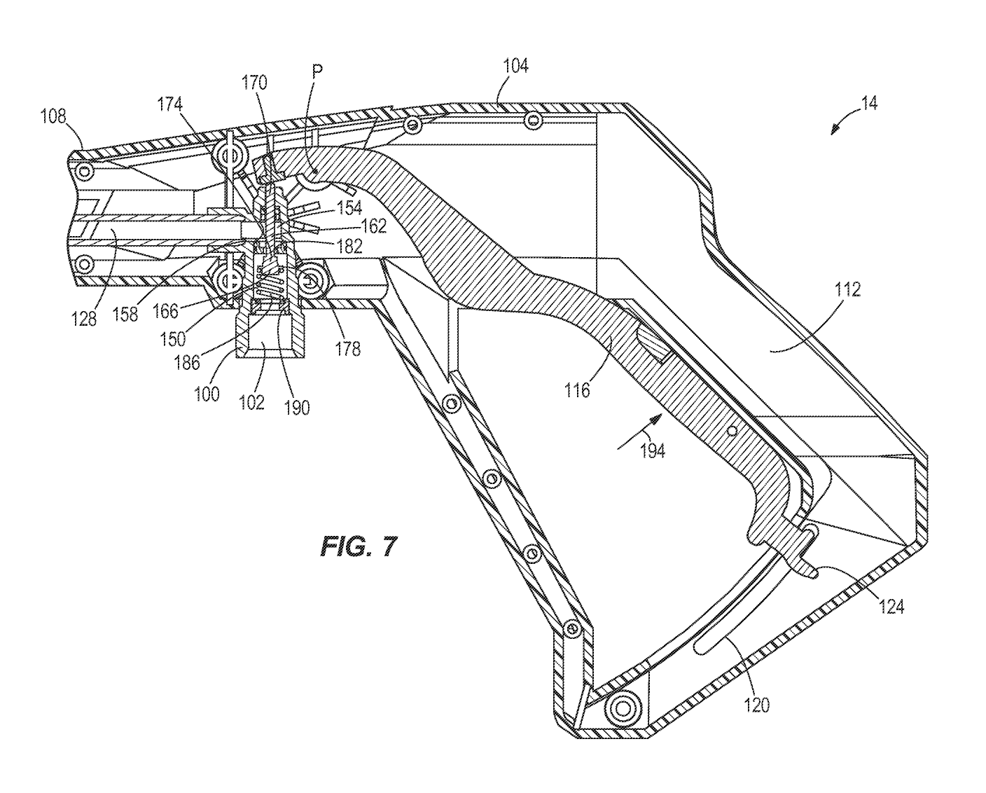

The trigger 116 is pivotable relative to the body 104 to selectively determine an amount of fluid that passes from the spray gun fluid inlet 102 to the spray gun fluid outlet 132. The trigger 116 is movable between a first or closed position (FIG. 5) and second position (FIG. 7). As the trigger 116 pivots between the first position and the second position, the piston 162 moves perpendicular to the longitudinal axis A of the spray gun 14.

With respect to FIG. 5, when the trigger 116 is in the first position, the biasing mechanism 186 is in an extended position to bias the valve member 166 such that at least a portion of the valve member 166 is retained within the aperture 182 in the valve seat 158. In the first position, the valve member 166 prevents fluid flow between the spray gun fluid inlet 102 to the spray gun fluid outlet 132, and in particular, between the first chamber 150 and the second chamber 154 of the valve housing 100.

With respect to FIG. 7, when the trigger 116 is in the second position, the valve member 166 is displaced from the first valve seat 158 such that the linkage 170 extends through the aperture 182 in the first valve seat 158 and is at least partially positioned in both the first chamber 150 and the second chamber 154, thereby compressing the biasing mechanism 186 against the second valve seat 190. In the second position, the aperture 182 in the first valve seat 158 is substantially unobstructed thereby allowing fluid to flow between the spray gun fluid inlet 102 to the spray gun fluid outlet 132, and in particular, the first chamber 150 and the second chamber 154 of the valve housing 100. When the trigger 116 is in the second position, fluid flow along the fluid flow path through the spray gun 14 is at a maximum.

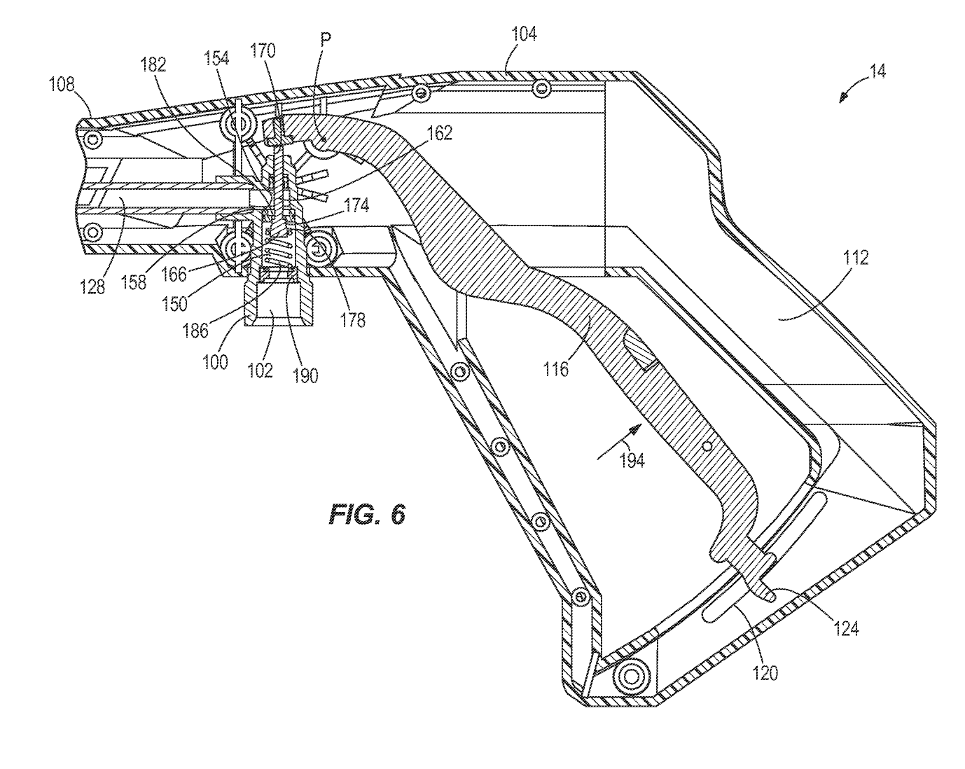

The trigger 116 is pivotable between the first position and second position to selectively allow fluid to flow along the fluid flow path from the spray gun fluid inlet 102 to the spray gun fluid outlet 132. Therefore, as the trigger 116 is depressed from the first position to the second position in the direction of arrow 194, the valve member 166 is gradually displaced from the first valve seat 158 against the bias of the biasing mechanism 186, thereby increasing the fluid flow along the flow path. The tapered outer diameter of the conical portion 174 defines the amount of fluid flow through the aperture 182. Accordingly, the tapered diameter of the conical portion 174 gradually moves out of contact with the aperture 182 in the first valve seat 158 such that fluid is gradually able to move from the first chamber 150 to the second chamber 154. In other words, as the trigger 116 is depressed, less of the conical portion 174 is received within the aperture 182. As such, narrower portions of the tapered outer diameter of the conical portion 174 create a greater distance between the conical portion 174 and the aperture 182, and therefore, a greater fluid flow through the spray gun 14. Similarly, as the trigger 116 is released from the second position to the first position in a direction opposite arrow 194, the tapered outer diameter of the conical portion of the valve member 166 is gradually re-positioned within the aperture 186 in the first valve seat 158 thereby increasingly extending the biasing mechanism 186 to reduce the fluid flow along the flow path. In other words, as the trigger 116 is released, more of the conical portion 174 is received within the aperture 182. As such, wider portions of the tapered outer diameter of the conical portion 174 create a smaller distance between the conical portion 174 and the aperture 182, and therefore, a lesser fluid flow through the spray gun 14. Accordingly, the trigger 116 includes at least one intermediate position (FIG. 6), in which fluid is permitted to flow along the flow path but the fluid flow is reduced from the maximum fluid flow. Further, a user can use the position of the trigger 116 relative to the body 104 to regulate movement of the piston 162 relative to the first valve seat 158 and therefore, the amount of fluid expelled through the spray gun fluid outlet 132. Therefore, fluid flow through the spray gun 14 is controlled by travel of the trigger 116.

Various features and advantages of the invention are set forth in the following claims.

What is claimed is:

1. A spray gun for use with a pressure washer, the spray gun comprising:
a body including a nozzle and a handle;
a trigger coupled to the body and pivotable relative to the handle;
a conduit extending through the nozzle and defining a fluid outlet;
a valve housing coupled to the conduit and defining a fluid inlet, the valve housing including a first chamber spaced apart from a second chamber and a valve seat including an aperture separating the two chambers;
a piston including a valve member and a linkage, the valve member moveably disposed within the first chamber and the linkage extending between the trigger and the valve member;
a biasing mechanism positioned within the first chamber;
wherein the trigger is pivotable between a first position, in which the biasing mechanism biases the valve member such that at least a portion of the valve member is retained within the aperture in the valve seat, and a second position, in which the valve member is spaced apart from the valve seat against the bias of the biasing mechanism; and
wherein pivotal movement of the trigger between the first position and the second position selectively determines an amount of fluid that passes from the fluid inlet to the fluid outlet.

2. The spray gun of claim 1, and further comprising a fluid flow passage wherein fluid flows from the inlet sequentially through the first chamber, the aperture, the second chamber, and the conduit to the outlet.

3. The spray gun of claim 1 wherein the linkage and the valve member are moveable in a direction that is substantially perpendicular to a longitudinal axis of the nozzle.

4. The spray gun of claim 1 wherein the trigger includes a first end that is pivotally coupled to the body and a second end that is slideable within a channel formed in the handle.

5. The spray gun of claim 1, and further comprising a second valve seat spaced apart from the first valve seat and positioned within the first chamber.

6. The spray gun of claim 5 wherein pivoting the trigger from the first position to the second position causes the valve member to compress the biasing mechanism against the second valve seat.

7. The spray gun of claim 5 wherein pivoting the trigger from the second position to the first position causes the valve member to move towards the first valve seat thereby restoring the bias of the biasing mechanism.

8. The spray gun of claim 1 wherein when the trigger is in the first position, the linkage is at least partially disposed within the second chamber.

9. The spray gun of claim 1 wherein the trigger is in the second position, the linkage extends through the aperture in the valve seat such that at the linkage is partially located in both the first chamber and the second chamber.

10. The spray gun of claim 1 wherein the conduit is fluidly coupled to the second chamber of the valve housing.

11. A spray gun for use with a pressure washer, the spray gun comprising:
a body including a nozzle and a handle;
a trigger coupled to the body and pivotable relative to the handle;
a conduit extending through the nozzle and defining a fluid outlet;
a valve housing coupled to the conduit and defining a fluid inlet, the valve housing including a first chamber spaced apart from a second chamber and separated by a valve seat including an aperture;
a piston including a valve member and a linkage, the valve member moveably disposed within the first chamber and the linkage extending between the trigger and the valve member;
a biasing mechanism positioned within the chamber and configured to bias the valve member such that at least a portion of the valve member is retained within the aperture in the valve seat;
wherein actuation of the trigger displaces the valve member and the linkage against the bias of the biasing mechanism to selectively allow fluid to flow from the inlet to the outlet through the aperture.

12. The spray gun of claim 11 wherein at least a portion of the valve member includes a body including a substantially conical portion having a tapered outer surface and a flange.

13. The spray gun of claim 11 wherein when the trigger is in a first position, at least a portion of the valve member is positioned within the aperture in the valve seat and the valve member prevents fluid flow from the fluid inlet to the fluid outlet.

14. The spray gun of claim 13 wherein when the trigger is in second position, the valve member is spaced apart from the aperture in the valve seat to allow maximum fluid flow from the fluid inlet to the fluid outlet.

15. The spray gun of claim 14 wherein the trigger is selectively pivotable between the first position and the second position.

16. The spray gun of claim 15 wherein as the trigger is pivoted between the first position and the second position, a tapered outer diameter of the valve member moves relative the valve seat such that narrower portions of the tapered outer diameter create a bigger gap between the valve member and the valve seat thereby resulting in more fluid flow from the fluid inlet to the fluid outlet and wider portions of the tapered outer diameter create a smaller gap between the valve member and the valve seat thereby resulting in less fluid flow from the fluid inlet to the fluid outlet.

17. The spray gun of claim 11 wherein the linkage and the valve member are moveable in a direction that is substantially perpendicular to a longitudinal axis of the nozzle.

18. The spray gun of claim 11 wherein one end of the trigger is slideable within a channel in the handle.

19. The spray gun of claim 11 wherein the valve housing includes a first end and a second end, the second end defining a stop surface for an end of the trigger.

20. The spray gun of claim 11 wherein the trigger is coupled to the linkage at a first location and coupled to the body at a second location, the first location being spaced apart from the second location.

21. The spray gun of claim 11 wherein the conduit is fluidly coupled to the second chamber of the valve housing.

22. The spray gun of claim 11, and further comprising a fluid flow passage wherein fluid flows from the inlet sequentially through the first chamber, the aperture, the second chamber, and the conduit to the outlet.

23. A pressure washer for pressurizing and spraying fluid from a source of fluid, the pressure washer comprising:
a base including at least,
a base fluid inlet configured to connect to the source of fluid,
a pump including a base fluid outlet, and
a spray gun including:
a body including a nozzle and a handle;
a trigger coupled to the body and pivotable relative to the handle;
a conduit extending through the nozzle and defining a spray gun fluid outlet;
a valve housing coupled to the conduit and defining a spray gun fluid inlet, the valve housing including a first chamber spaced apart from a second chamber and separated by a valve seat including an aperture;
a piston including a valve member and a linkage, the valve member moveably disposed within the chamber and the linkage extending between the trigger and the valve member;
a biasing mechanism positioned within the chamber and configured to bias the valve member such that at least a portion of the valve member is retained within the aperture in the valve seat;
a hose to provide fluid communication from the base fluid outlet to the spray gun fluid inlet;
wherein actuation of the trigger displaces the valve member and the linkage against the bias of the biasing mechanism to selectively allow fluid to flow from the source to the outlet through the aperture.

24. The pressure washer of claim 23 wherein when the trigger is in a first position, at least a portion of the valve member is positioned within the aperture in the valve seat and the valve member prevents fluid flow from the spray gun fluid inlet to the spray gun fluid outlet.

25. The pressure washer of claim 24 wherein when the trigger is in second position, the valve member is spaced apart from the aperture in the valve seat to allow maximum fluid flow from the spray gun fluid inlet to the spray gun fluid outlet.

26. The pressure washer of claim 25 wherein the trigger is selectively pivotable between the first position and the second position.

27. The pressure washer of claim 26 wherein as the trigger is pivoted between the first position and the second position, a tapered outer diameter of the valve member moves relative to the valve seat such that narrower portions of the tapered outer diameter create a bigger gap between the valve member and the valve seat thereby resulting in more fluid flow from the fluid inlet to the fluid outlet and wider portions of the tapered outer diameter create a smaller gap between the valve member and the valve seat thereby resulting in less fluid flow from the fluid inlet to the fluid outlet.
